(19) United States
(12) Patent Application Publication
(10) Pub. No.: US 2022/0038684 A1
(43) Pub. Date: Feb. 3, 2022

(54) MULTI-REFERENCE LINE INTRA PREDICTION AND MOST PROBABLE MODE

(71) Applicant: InterDigital VC Holdings, Inc., Wilmington, DE (US)

(72) Inventors: Fabrice URBAN, Cesson-Sevigne (FR); Fabien RACAPE, Los Altos, CA (US); Gagan RATH, Cesson-Sevigne (FR)

(21) Appl. No.: 17/279,221

(22) PCT Filed: Oct. 30, 2019
(86) PCT No.: PCT/US2019/058828

§ 371 Date: Mar. 24, 2021

(30) Foreign Application Priority Data
Oct. 31, 2018 (EP) 18306431.0

(51) Int. Cl. H04N 19/105; H04N 19/159; H04N 19/70; H04N 19/176

(52) U.S. Cl. CPC H04N 19/105; H04N 19/176; H04N 19/70; H04N 19/159

(57) ABSTRACT

At least a method and an apparatus are provided for efficiently encoding or decoding video. For example, multiple reference lines for intra prediction of a current block are obtained, wherein the multiple reference lines include at least one reference line that is immediately adjacent to the current block and at least one reference line that is not immediately adjacent to the current block. A number of intra prediction candidate modes are obtained respectively for each of the multiple reference lines. The current block is encoded based on the respective number of candidate modes for each of the multiple reference lines.

### TECHNICAL FIELD

At least one of the present embodiments generally relates to a method or an apparatus for video encoding or decoding, and more particularly, to a method or an apparatus for efficiently providing video compression using multi-reference line (MRL) intra prediction and most probable mode (MPM).

### BACKGROUND

To achieve high compression efficiency, image and video coding schemes usually employ prediction and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transformation, and prediction.

Recent additions to video compression technology include various industry standards, versions of the reference software and/or documentations such as Joint Exploration Model (JEM) and later VTM (Versatile Video Coding (VVC) Test Model) being developed by the JVET (Joint Video Exploration Team) group. These additions aim to make further improvements to the existing HEVC (High Efficiency Video Coding) standard.

### SUMMARY

The drawbacks and disadvantages of the prior art are solved and addressed by one or more aspects described herein.

According to an embodiment, a method for video encoding is provided, comprising: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; and encoding the current block based on the respective number of candidate modes for each of the multiple reference lines.

According to another embodiment, a method for video decoding is provided, comprising: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; and decoding the current block based on the respective number of candidate modes for each of the multiple reference lines.

According to another embodiment, an apparatus for video encoding is provided, comprising: means for obtaining multiple reference lines for intra prediction of a current block, wherein the multiple reference lines include at least one reference line that is immediately adjacent to the current block and at least one reference line that is not immediately adjacent to the current block; means for obtaining respectively a number of intra prediction candidate modes for each of the multiple reference lines; and means for encoding the current block based on the respective number of candidate modes for each of the multiple reference lines.

According to another embodiment, an apparatus for video decoding is provided, comprising: means for obtaining multiple reference lines for intra prediction of a current block, wherein the multiple reference lines include at least one reference line that is immediately adjacent to the current block and at least one reference line that is not immediately adjacent to the current block; means for obtaining respectively a number of intra prediction candidate modes for each of the multiple reference lines; and means for decoding the current block based on the respective number of candidate modes for each of the multiple reference lines.

According to another embodiment, an apparatus for video encoding is presented, comprising one or more processors, wherein said one or more processors are configured to: obtain multiple reference lines for intra prediction of a current block, wherein the multiple reference lines include at least one reference line that is immediately adjacent to the current block and at least one reference line that is not immediately adjacent to the current block; obtain respectively a number of intra prediction candidate modes for each of the multiple reference lines; and encode the current block based on the respective number of candidate modes for each of the multiple reference lines.

According to another embodiment, an apparatus for video decoding is presented, comprising one or more processors, wherein said one or more processors are configured to: obtain multiple reference lines for intra prediction of a current block, wherein the multiple reference lines include at least one reference line that is immediately adjacent to the current block and at least one reference line that is not immediately adjacent to the current block; obtain respectively a number of intra prediction candidate modes for each of the multiple reference lines; and encode the current block based on the respective number of candidate modes for each of the multiple reference lines.

According to another embodiment, a signal comprising encoded video is formed by performing: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; encoding the current block based on the respective number of candidate modes for each of the multiple reference lines; and forming the bitstream comprising the encoded current block.

### BRIEF DESCRIPTION OF THE DRAWINGS

FIG. 1 illustrates reference samples for intra prediction in HEVC.

FIG. 2A illustrates intra prediction directions in HEVC and FIG. 2B illustrates intra prediction directions in VTM.

FIG. 3 illustrates an intra mode direction signaling process using MPM.

FIG. 4 illustrates multi-type tree splitting modes.

FIG. 5 illustrates reference samples for wide-angle intra prediction.

FIG. 6 illustrates problem of discontinuity in case of directions beyond 45 degree.

FIG. 7 illustrates definition of samples used by PDPC applied to diagonal and adjacent angular intra modes.

FIG. 8 illustrates an example of MRL having four reference lines neighboring to a prediction block.

FIG. 9 illustrates a process for 3-MPM list derivation.

FIG. 10 illustrates possible neighboring reference blocks for used in prediction of a current block.

FIG. 11 illustrates a process for 6-MPM list derivation.

FIG. 12 illustrates a process for MPM list derivation for 6-MPM and MRL.

FIG. 13 illustrates a process for intra coding mode signaling with 6-MPM and MRL.

FIG. 14 illustrates neighboring blocks directions availability at picture or CTU boundaries.

FIG. 15 illustrates a block diagram of an embodiment of a video encoder.

FIG. 16 illustrates a block diagram of an embodiment of a video decoder

FIG. 17 illustrates a block diagram of a system within which aspects of the present embodiments may be implemented.

### DETAILED DESCRIPTION

Intra prediction in video compression refers to the spatial prediction of a block of pixels using the information from the causal neighbor blocks, that is, the neighboring blocks in the same frame which have already been decoded. This is a powerful coding tool since it allows for high compression efficiency in intra frames, as well as in inter frames whenever there is no better temporal prediction. Therefore, intra prediction has been included as a core coding tool in all video compression standards including H.264/AVC, HEVC, and etc. In the following, for explanation purpose, we will refer to the intra prediction in HEVC standard and the current efforts to improve upon it, such as the VTM.

H.265/HEVC has been designed to capture directionalities of object orientations and slow changing intensity regions or textures. In the Versatile Video Coding (VVC) Test Model (VTM) (see, e.g., “Algorithm description for Versatile Video Coding and Test Model 2”, JVET-K1002-v1, July 2018), which aims at designing the future standard H.266/VVC, the number of prediction modes has been set to 67, including Planar, DC and 65 directional modes, to accommodate many directions especially for large block sizes. In the case of directional prediction modes, the filtered pixel values from neighboring left and top neighbors are repeated in predefined directions.

Among the 67 available modes, the one that is chosen by the encoder is signaled to the decoder. The Most Probable Modes (MPM) method enables to reduce the cost of this information by giving a lighter syntax to modes which are statistically more frequently used and by reusing the modes chosen for the current block's already decoded neighbors.

In the reference VVC Test Model (VTM) under study by the Joint Video Experts Team (WET), 6 modes out of 67 are selected in a list of MPM (6-MPM). Selecting candidate modes and sorting this list has an impact on both the coding cost and the computational complexity of the method.

Intra prediction using Multiple Reference Line (MRL) has recently been adopted in VVC. It consists in using a reference line (the index is signaled to the decoder) farther than the directly neighboring line. When the index is not 0, some intra prediction modes such as, e.g., DC and/or PLANAR are not allowed.

In this document, it is proposed to adapt the MPM list to MRL intra prediction. Specifically, when MRL is selected, a special MPM list is built. In one embodiment, when MRL index is non-zero, it is proposed to build a 6-MPM list without DC nor PLANAR, and fill 6-MPM list in case some neighboring blocks are not available.

In HEVC, encoding of a frame of video sequence is based on a quad-tree (QT) block structure. A frame is divided into square coding tree units (CTUs) which all undergo quad-tree based splitting to multiple coding units (CUs) based on rate-distortion criteria. Each CU contains at least one prediction unit (PU), which are the basis blocks for prediction tools. In intra prediction, a PU is spatially predicted from the causal neighbor PUs, i.e., the PUs on the top and the left. For that purpose, HEVC uses simple spatial models called prediction modes. Based on the decoded pixel values in the top and left PUs, called reference pixels, the encoder constructs different predictions for the target block and chooses the one that leads to the best RD (rate-distortion) performance. Out of the 35 defined modes, one is a planar mode (indexed as mode 0), one is a DC mode (indexed as mode 1) and the remaining 33 (indexed as mode 2-34) are angular modes (i.e., directional modes). The angular modes aim to model the directional structures of objects in a frame. Therefore, the decoded pixel values in the top and left CUs are simply repeated along the defined directions to fill up the target block. Since this process can lead to discontinuities along the top and left reference boundaries for certain modes, those prediction modes include a subsequent post-filtering to smoothen the pixel values along those boundaries.

Once predicted, the difference between the original block and the predicted block, called the residual, is transformed, quantized and the resulting coefficients are coded. On the decoder side, the coefficients are decoded if any, then inverse quantized and inverse transformed, to finally be added to the prediction (i.e., the predicted block). In VVC, multiple sets of transforms/inverse transforms can be used.

Before we describe the proposed prediction models, we briefly present intra coding in HEVC and VVC in the following.

Intra Prediction in HEVC

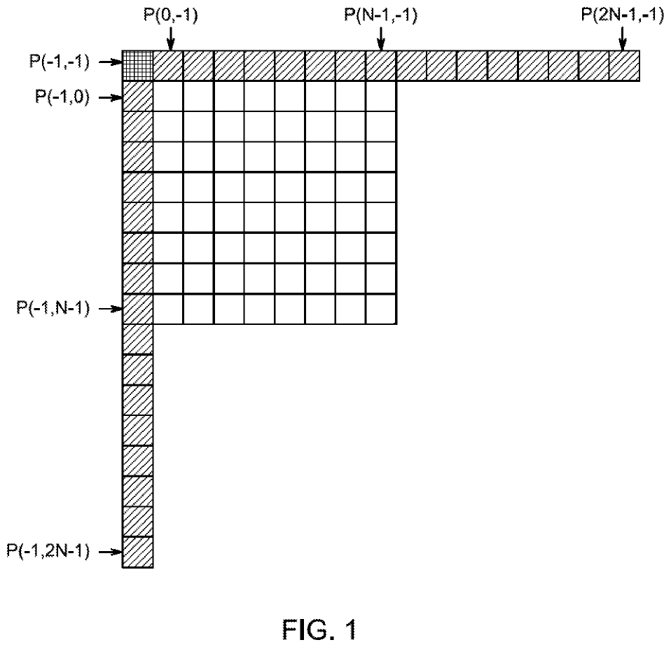

The intra prediction process in HEVC consists of three steps: (1) reference sample generation (2) intra sample prediction and (3) post-processing of predicted samples. The reference sample generation process is illustrated in FIG. 1. In FIG. 1, the pixel values at co-ordinates (x,y) are indicated in the figure by P(x,y). For a PU of size N×N, a row of 2N decoded samples on the top is formed from the previously reconstructed top and top right pixels to the current PU. Similarly, a column of 2N samples on the left is formed from the reconstructed left and below left pixels. The corner pixel at the top-left position is also used to fill up the gap between the top row and the left column references. If some of the samples on top or left are not available, because of the corresponding CUs not being in the same slice, or the current CU being at a frame boundary, etc., then a method called reference sample substitution is performed where the missing samples are copied from the available samples in a clock-wise direction. Then, depending on the current CU size and the prediction mode, the reference samples are filtered using a specified filter.

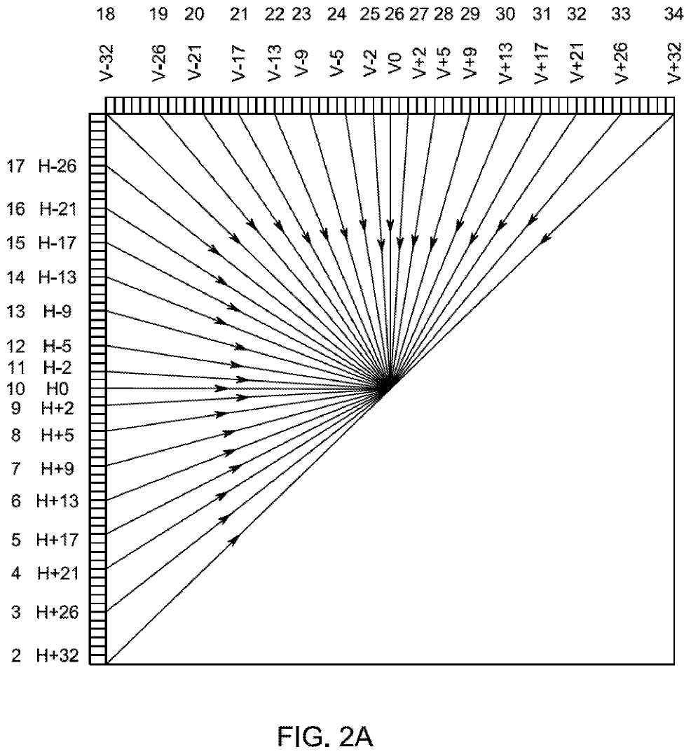

The next step, i.e., the intra sample prediction, consists of predicting the pixels of the target CU based on the reference samples. As mentioned before, in order to predict different kinds of content efficiently, HEVC supports a range of prediction models. Planar (mode 0) and DC (mode 1) prediction modes are used to predict smooth and gradually changing regions, whereas angular prediction modes are used to capture different directional structures. HEVC supports 33 directional prediction modes which are indexed from 2 to 34. These prediction modes correspond to different prediction directions as illustrated in FIG. 2A.

As shown in FIG. 2A, the defined angular directions have a sample accuracy of 1/32. That is, between any two adjacent reference samples, there are 32 possible directions. The defined directions can be distinguished as either vertical or horizontal. The predictions in horizontal directions use either only left reference samples or some left and some top reference samples. Similarly, the predictions in vertical directions use either only top reference samples or some top and some left reference samples. The directions which use only left reference samples or only the top reference samples are defined to be positive directions. Thus, we have horizontal positive directions from HO to H+32 that use only the left reference samples. Similarly, we have vertical positive directions from VO to V+32 that use only the top reference samples. Other horizontal and vertical directions (H-2 to H-26 and V-2 to V-32) are defined to be negative directions and they use reference samples both on the left and on the top. The table below shows the relationship between the prediction mode and the angle parameter A as specified by HEVC:

TABLE 1
Mapping of mode index to angle parameter A
Horizontal directions

| Mode | | | | | | | | | | | | | | | | |
|---|---|---|---|---|---|---|---|---|---|---|---|---|---|---|---|---|
| index | 2 | 3 | 4 | 5 | 6 | 7 | 8 | 9 | 10 | 11 | 12 | 13 | 14 | 15 | 16 | 17 |
| A | 32 | 26 | 21 | 17 | 13 | 9 | 5 | 2 | 0 | −2 | −5 | −9 | −13 | −17 | −21 | −26 |

Vertical directions

| Mode | | | | | | | | | | | | | | | | | |
|---|---|---|---|---|---|---|---|---|---|---|---|---|---|---|---|---|---|
| index | 18 | 19 | 20 | 21 | 22 | 23 | 24 | 25 | 26 | 27 | 28 | 29 | 30 | 31 | 32 | 33 | 34 |
| A | −32 | −26 | −21 | −17 | −13 | −9 | −5 | −2 | 0 | 2 | 5 | 9 | 13 | 17 | 21 | 26 | 32 |

In HEVC reference code, a reference array is first constructed using the top and left reference samples. For vertical predictions, the reference array is horizontal and for horizontal predictions, the reference array is vertical. For the modes with positive angle parameter A (modes 2 to 10 and 26 to 34), the reference array is simply the top or left reference samples depending on the direction:

topRef[x]=P[x−1][−1], 0≤x≤2N, for vertical predictions,

leftRef[y]=P[−1][y−1], 0≤y≤2N, for horizontal predictions,

where N is the CU size. It is conventional to initialize the sample co-ordinates to (0,0) at the top-left pixel of the target CU. Therefore, the top reference samples will have their y-coordinate as −1 and the left reference samples will have their x-co-ordinate as −1.

For the modes with negative angle parameter A (modes 11 to 25), the reference array needs pixels from both the top and left reference. In this case, the reference array will extend to the negative indices beyond 0. Sample values on the reference array with positive indices are obtained as above depending on vertical or horizontal prediction. Those on the reference array with negative indices are obtained by projecting the left (for vertical predictions) or top reference pixels (for horizontal predictions) on the reference array along the prediction direction.

Once the reference array is constructed, the prediction Pred(x, y) at any pixel position (x, y) inside the target CU is obtained by projecting the pixel position to the reference array along the selected direction and then copying the reference array sample value at (x, y). The reference sample value is computed at a sample resolution of ( 1/32) by interpolating between two adjacent samples as illustrated below:

Pred[x][y]=((32−f)*topRef[x+i+1]+f*topRef[x+i+2]+16)>>5), 0≤x, y<N, for vertical predictions,

Pred[x][y]=((32−f)*leftRef[y+i+1]+f*leftRef[y+i+2]+16)>>5), 0≤x, y<N, for horizontal predictions,

where i and f denote the integer part and the fractional part of the projected displacement from the pixel location (x, y).

If Δ denotes the projected displacement, then

Δ=(x+1)*A, for horizontal predictions, and

Δ=(y+1)*A, for vertical predictions,

i=Δ>>5,

f=Δ& 31.

Notice that, if f=0, that is, there is no fractional part, then the prediction is equal to the reference array sample in the direction of prediction.

As we observe from the above expressions, the vertical predictions are independent of the y-coordinate and the horizontal predictions are independent of the x-coordinate. This means that, for vertical predictions, the prediction values are repeated along the direction of prediction from the reference array on the top. Similarly, for horizontal predictions, the prediction values are repeated along the direction of prediction from the reference array on the left. Therefore, if two or more pixel co-ordinates have the same projection point on the reference array, they have identical prediction values.

VTM Extensions

In the VTM code, the number of prediction modes has been increased to 67, which includes one planar mode, one DC mode, and 65 angular modes, as shown in FIG. 2B. The higher number of angular modes correspond to 65 prediction directions where the prediction directions correspond to the 33 directions in HEVC plus additional 32 directions that correspond to the middle of any two adjacent directions. In other words, the prediction direction in VTM has twice the angle resolution of HEVC. The higher number of prediction modes have been proposed to exploit the possibility of such angular structures with proposed higher block sizes. Corresponding to higher number of modes, we have higher number of angle parameter A values. The modes are numbered from 2 to 66 in the increasing order and in the same fashion as done in HEVC from 2 to 34.

Multi-Type Tree Splitting Modes

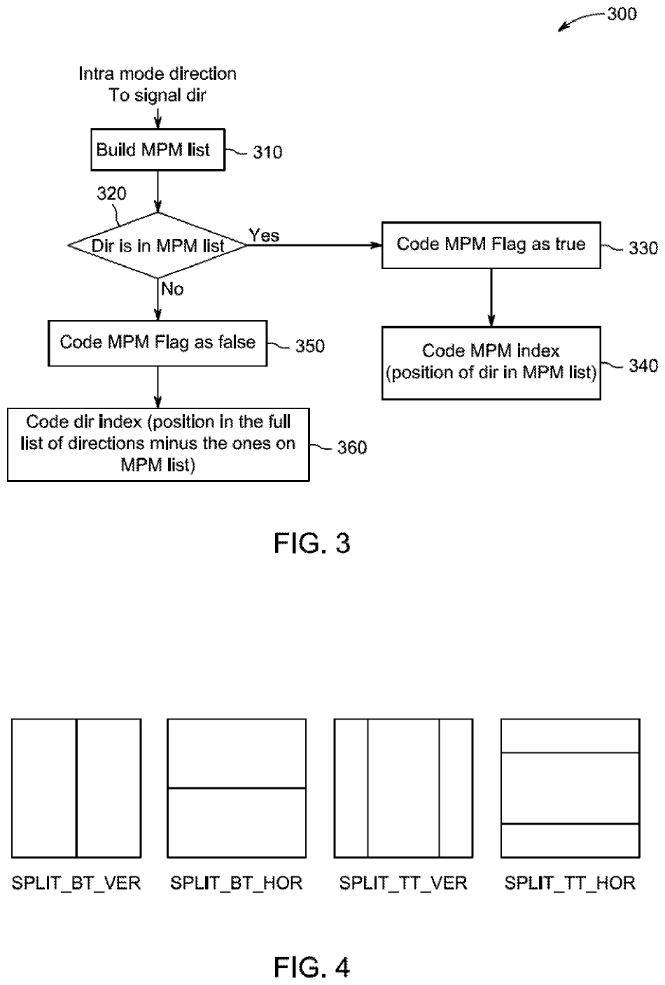

In addition to the square CUs, VTM can also have rectangular CUs because of Multi-type tree (MTT) splitting modes, as shown in FIG. 4. In this case, a block can be split into two or three blocks. The former is referred to as binary tree splitting (BT Split) and the latter is referred to as triple tree splitting (TT Split). In this case, for positive directions, the reference array is constructed as follows:

topRef[x]=P[x−1][−1], 0≤x≤W+H, for vertical predictions,

leftRef[y]=P[−1][y−1], 0≤y≤W+H, for horizontal predictions,

where W and H denote the width and the height of the target CU, respectively. The prediction process basically remains the same as in HEVC. The pixel values are computed as:

P[x][y]=((32−f)*topRef[x+i+1]+f*topRef[x+i+2]+16)>>5, 0≤x<W, 0≤y<H, for vertical predictions,

P[x][y]=((32−f)*leftRef[y+i+1]+f*leftRef[y+i+2]+16)>>5, 0≤x<W, 0≤y<H, for horizontal predictions,

As in HEVC, the directions have a sample accuracy of ( 1/32).

Signaling of the Intra Prediction Mode

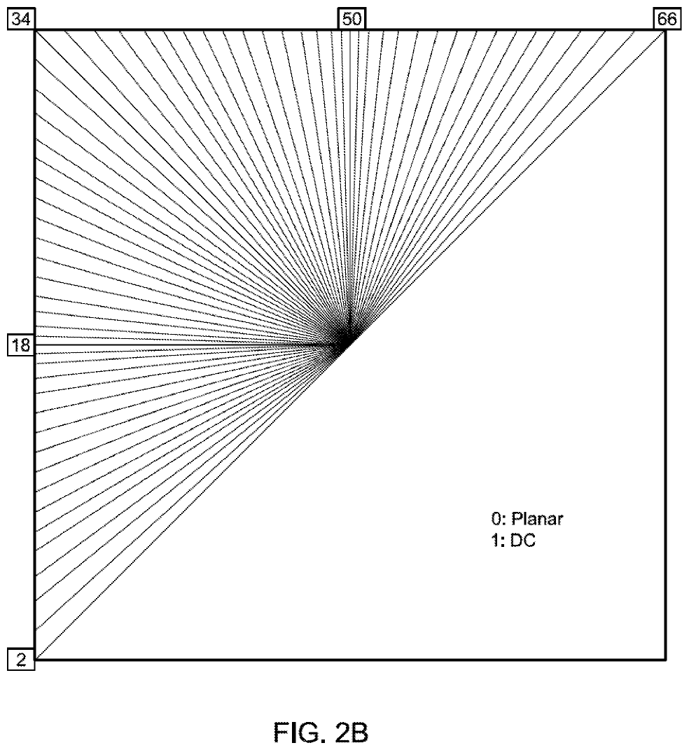

FIG. 3 illustrates an intra mode direction signaling process 300 using Most Probable Modes (MPM). A list of MPM is constructed from predefined modes and neighboring blocks' prediction modes (310-360). If the current block prediction is in the MPM list, an MPM flag is transmitted as true (320, 330), followed by the MPM index (340). Otherwise the MPM flag is transmitted as false (350), followed by the mode index (360) as depicted in FIG. 3.

Coding unit syntax of the intra prediction mode is described below:

| | Descriptor |
|---|---|
| coding_unit( x0, y0, cbWidth, cbHeight, treeType) { | |
| if( slice_type != I ) { | |
| cu_skip_flag[ x0 ][ y0 ] | ae(v) |
| if( cu_skip_flag[ x0 ][ y0 ] = = 0 ) | |
| pred_mode_flag | ae(v) |
| } | |
| if( CuPredMode[ x0 ][ y0 ] = = MODE_INTRA){ | |
| if( treeType = = SINGLE_TREE \| \| treeType = = DUAL_TREE_LUMA) { | |
| intra_luma_mpm_flag[ x0 ][ y0 ] | ae(v) |
| if( intra_luma_mpm_flag[ x0 ][ y0 ] ) | |
| intra_luma_mpm_idx[ x0 ][ y0 ] | ae(v) |
| else | |
| intra_luma_mpm_remainder[ x0 ][ y0 ] | ae(v) |
| } | |
| if( treeType = = SINGLE_TREE \| \| treeType = = DUAL_TREE_CHROMA) | |
| intra_chroma_pred_mode[ x0 ][ y0 ] | ae(v) |
| } else { /* MODE_INTER */ | |
| . . . | |

Wide-Angle Intra Prediction for Non-Square Blocks

Conventional angular intra prediction directions are defined from 45 degrees to −135 degrees in clockwise direction. Several conventional angular intra prediction modes are adaptively replaced with wide-angle intra prediction modes for non-square blocks. The replaced modes are signaled using the original method and remapped to the indexes of wide angular modes after parsing. The total number of intra prediction modes for a certain block is unchanged, i.e., 67, and the intra mode coding is unchanged.

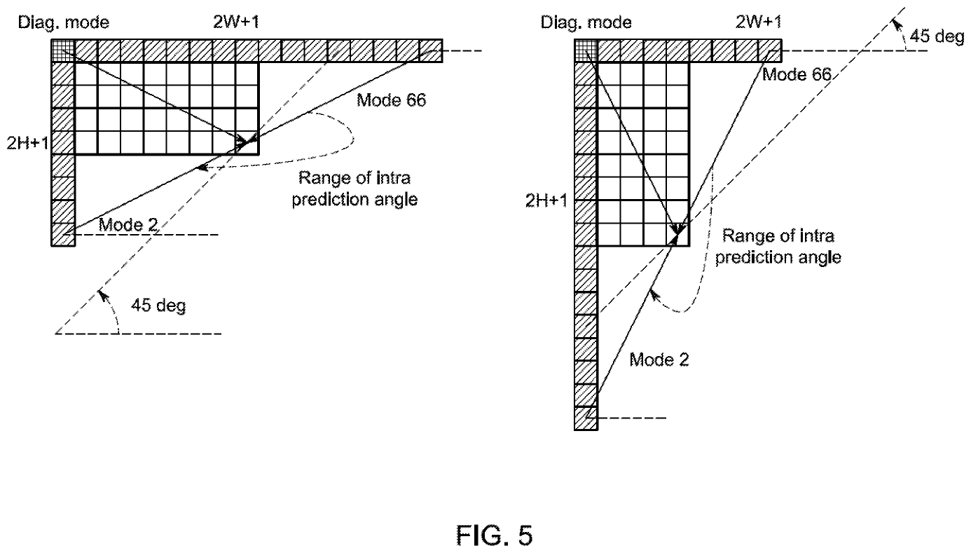

To support these prediction directions, the top reference with length 2 W+1, and the left reference with length 2H+1, are defined as shown in FIG. 5.

The mode number of the replaced mode in wide-angle direction mode is dependent on the aspect ratio of a block. The replaced intra prediction modes are illustrated in Table 2.

TABLE 2
Intra prediction modes replaced by wide-angle modes

| Condition | Replaced intra prediction modes |
|---|---|
| W/H = = 2 | Modes 2, 3, 4, 5, 6, 7 |
| W/H > 2 | Modes 2, 3, 4, 5, 6, 7, 8, 9, 10, 11 |
| W/H = = 1 | None |
| H/W = = 1/2 | Modes 61, 62, 63, 64, 65, 66 |
| H/W < 1/2 | Mode 57, 58, 59, 60, 61, 62, 63, 64, 65, 66 |

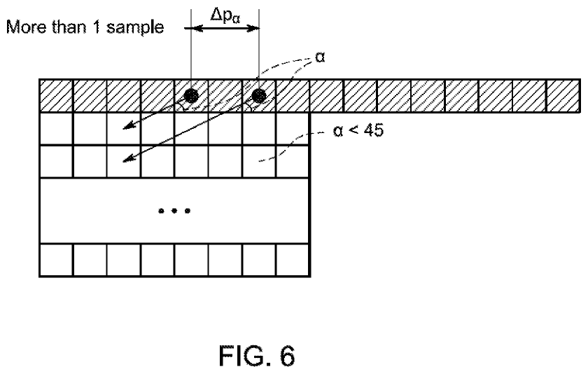

As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Apa.

Position Dependent Intra Prediction Combination

In the VTM2, the results of intra prediction of planar mode are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signalling: planar, DC, horizontal (18), vertical (50), bottom-left angular mode and its eight adjacent angular modes, and top-right angular mode and its eight adjacent angular modes (called “adjacent modes”).

The prediction sample pred(x,y) is predicted using an intra prediction mode (DC, planar, angular) and a linear combination of reference samples according to the Equation 1 as follows:

pred(x,y)=(wL×R(−1,y)+wT×R(x,−1)−wTL xR(−1,−1)+(64−wL−wT+wTL)×pred(x,y)+32)>>6 (1)

where R(x,−1), R(−1,y) represent the reference samples located at the top and left of current sample (x, y), respectively, and R(−1,−1) represents the reference sample located at the top-left corner of the current block.

If PDPC is applied to DC, planar, horizontal, and vertical intra modes, additional boundary filters are not needed, as required in the case of HEVC DC mode boundary filter or horizontal/vertical mode edge filters.

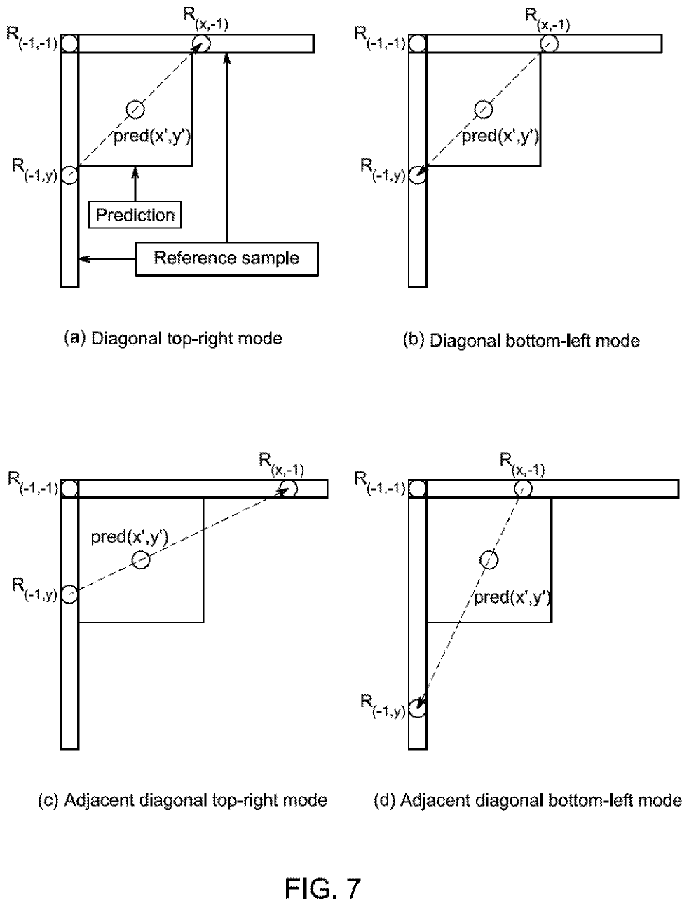

FIG. 7 illustrates the definition of reference samples (R(x,−1), R(−1,y) and R(−1,−1) for PDPC applied over various prediction modes. The prediction sample pred (x′, y′) is located at (x′, y′) within the prediction block. The coordinate x of the reference sample R(x,−1) is given by: x=x′+y′+1, and the coordinate y of the reference sample R(−1,y) is similarly given by: y=x′+y′ +1.

The PDPC weights are dependent on prediction modes and are shown in Table 3.

TABLE 3
Example of PDPC weights according to prediction modes

| Prediction modes | wT | wL | wTL |
|---|---|---|---|
| Diagonal top-right | 16 >> ( ( y′ << | 16 >> ( ( x′ << 1 ) >> shift) | 0 |
| | 1 ) >> shift) | | |
| Diagonal bottom-left | 16 >> ( ( y′ << | 16 >> ( ( x′ << 1 ) >> shift) | 0 |
| | 1 ) >> shift) | | |
| Adjacent diagonal | 32 >> ( ( y′ << | 0 | 0 |
| top-right | l ) >> shift) | | |
| Adjacent diagonal | 0 | 32 >> ( ( x′ << 1 ) >> shift) | 0 |
| bottom-left | | | |

shift = ((log2[width]-2 + log2[height]-2 + 2) >> 2)

MTS—Multiple Transform Selection for Core Transform

In addition to DCT-II which has been employed in HEVC, a Multiple Transform Selection (MTS) scheme is used for residual coding for both inter and intra coded blocks. It uses multiple selected transforms from DCT8/DST7. The newly introduced transform matrices are DST-VII and DCT-VIII. Table 4 shows the basis functions of the selected DST/DCT.

TABLE 4
Transform basis functions of DCT-II/VIII and DST-VII for N-point input

| Transform Type | Basis function Ti(j), 1, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} ) , where$ |
| | ${ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at the SPS level for intra and inter modes, respectively. When MTS is enabled at the SPS, a CU level flag is signaled to indicate whether MTS is applied or not. Here, MTS is applied only for luma. The MTS CU level flag is signaled when the following conditions are satisfied:
Both width and height are smaller than or equal to 32.
CBF flag is equal to one.

If MTS CU flag is equal to zero, then DCT2 is applied in both directions. However, if MTS CU flag is equal to one, then another two flags are additionally signaled to indicate the transform type for the horizontal and vertical directions, respectively. For an intra CU, those two flags (i.e., MTS_Hor_flag and MTS_Ver_flag) are signaled when the number of non-zero coefficients is greater than two. However, for an inter CU, regardless of the number of non-zero coefficients, those flags are signaled. For example, for an intra CU with only 1 or 2 non-zero coefficients, DST7 is used both horizontally and vertically without signaling the additional two flags when the MTS CU flag is equal to one. Transform and signalling mapping table are shown in Table 5.

TABLE 5
Transform and signaling mapping table

| MTS_ | MTS_ | MTS_ | | | | |
|---|---|---|---|---|---|---|
| CU_ | Hor_ | Ver_ | Intra | | Inter | |
| flag | flag | flag | Horizontal | Vertical | Horizontal | Vertical |
| 0 | n/a | n/a | DCT2 | | | |
| 1 | 0 | 0 | DST7 | DST7 | DCT8 | DCT8 |
| | 0 | 1 | DCT8 | DST7 | DST7 | DCT8 |
| | 1 | 0 | DST7 | DCT8 | DCT8 | DST7 |
| | 1 | 1 | DCT8 | DCT8 | DST7 | DST7 |

As in HEVC, the residual of a block can be coded with transform skip mode. To avoid the redundancy of syntax coding, the transform skip flag is not signaled when the CU level MTS CU flag is not equal to zero. For inter prediction residual, the signaling of DST-VII and DCT-VIII is applied reversely as shown in the Table 5.

Multiple Reference Line (MRL) Intra Prediction

Multiple reference line (MRL) intra prediction was proposed to use more reference lines for intra prediction. The index of selected reference line (mrl_idx) is signaled and used to generate the intra predictor. If the reference line index is not zero, the prediction direction is transmitted through an MPM list. The reference line index is signaled before intra prediction modes, and Planar and DC modes may be excluded from intra prediction modes in case a nonzero reference line index is signaled.

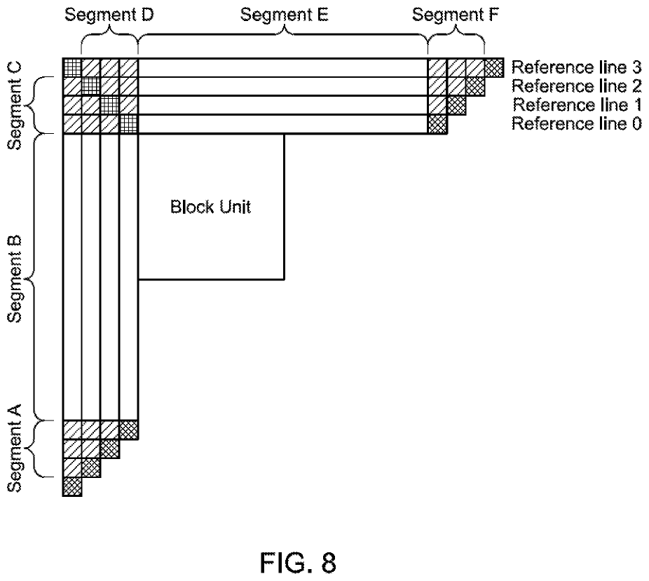

In FIG. 8, an example of 4 reference lines is depicted, where the samples of segments A and F are not fetched from reconstructed neighboring samples but padded with the closest samples from Segment B and E, respectively.

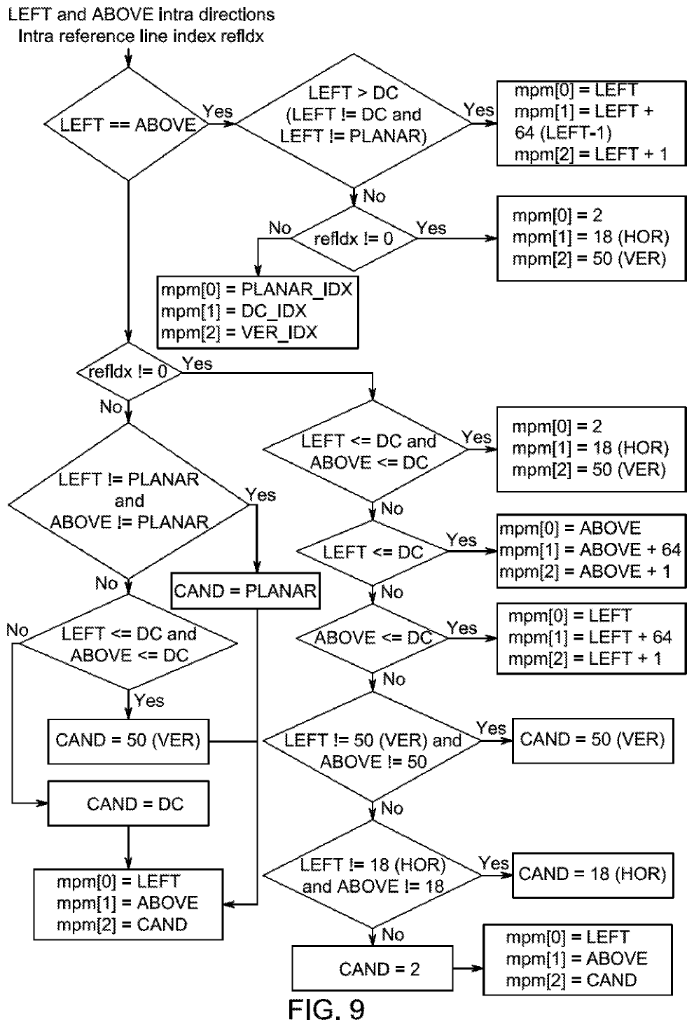

The following aspects have been studied at JVET meeting in Macao 2018 in CE3-1.1:
Additional reference lines (current intra-picture prediction uses the nearest reference line, i.e., reference line 0):
   2 additional lines are added, 3 lines in total: 0, 1, 3 (JVET-K0051, see “CE3: Multiple reference line intra prediction (Test 5.4.1, 5.4.2, 5.4.3 and 5.4.4)”, JVET-K0051, July 2018).
Intra prediction modes used for additional reference lines:
   Angular modes (JVET-K0051, JVET-K0277 (see “CE3: Number of extended reference line for intra prediction (Test 5.5.1 and 5.5.2)”, JVET-K0277, July 2018)).
Reference line index signaling:
   Mode after reference line index (MPM only)—for reference line idx>0, only include additional reference line modes in the MPM list (means a modified MPM list if ref idx is not 0, as illustrated in FIG. 9. FIG. 9 illustrates a process for a 3-MPM list derivation) and only signal the mpm index without remaining mode (JVET-K0482 (see “CE3-related: MPM based multi-line intra prediction scheme”, JVET-K0482, July 2018), JVET-K0175 (see “CE3-related: Advanced MPM based on intra reference line selection scheme”, JVET-K0175, July 2018)).
Restrictions
   Top line of CTU restriction, i.e., disable MRL for the first line of blocks inside a CTU to prevent using extended reference samples outside the current CTU line (JVET-K0221 (see “CE3 Related: Additional results of JVET-J1023 Core Experiments 5.2.3, 5.2.4 and 5.2.5”, JVET-K0221, July 2018), JVET-K0166 (see “CE3: Multi-line based intra prediction (Test 5.3.1, 5.3.2, 5.3.3)”, JVET-K0166, July 2018), JVET-K0162 (see “CE3.5: Multiple Reference Intra Prediction (tests 5.2.1 and 5.2.2)”, JVET-K0162, July 2018)).
   PDPC, i.e., disable PDPC for additional line.

Coding unit syntax of the reference index is described below:

| | Descriptor |
|---|---|
| coding_unit( x0, y0, cbWidth, cbHeight, treeType) { | |
| if( slice_type != I ) { | |
| cu_skip_flag[x0][ y0 ] | ae(v) |
| if( cu_skip_flag[ x0 ][ y0 ] = = 0 ) | |
| pred_mode_flag | ae(v) |
| } | |
| if( CuPredMode[ x0 ][ y0 ] = = MODE_INTRA ) { | |
| if( treeType = = SINGLE_TREE \| \| treeType = = DUAL_TREE_LUMA){ | |
| if( ( y0 % CtbSizeY ) > 0 ) | |
| intra_luma_ref idx[ x0 ][ y0 ] | ae(v) |
| if (intra_luma_ref_idx[ x0 ][ y0 ] = =0) | |
| intra_luma_mpm_flag[ x0 ][ y0 ] | ae(v) |
| if( intra_luma_mpm_flag[ x0 ][ y0 ]) | |
| intra_luma_mpm_idx[ x0 ][ y0 ] | ae(v) |
| else | |
| intra_luma_mpm_remainder[ x0 ][ y0 ] | ae(v) |
| } | |
| if( treeType = = SINGLE_TREE \| \| treeType = = DUAL_TREE_CHROMA ) | |
| intra_chroma_pred_mode[ x0 ][ y0 ] | ae(v) |
| } else { /* MODE_INTER */ | |
| . . . | |

6-MPM

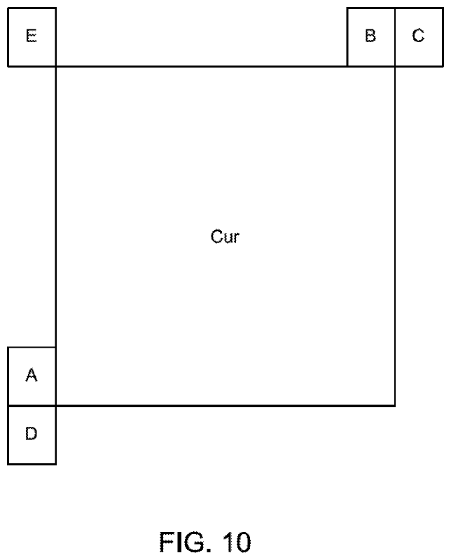

A simple extension from 3 to 6 MPM has been adopted. FIG. 10 shows possible neighboring reference blocks for use in prediction of a current block. As shown in FIG. 10, only the intra modes of neighbor position A and B denoted as LEFT and ABOVE are used for MPM list generation.

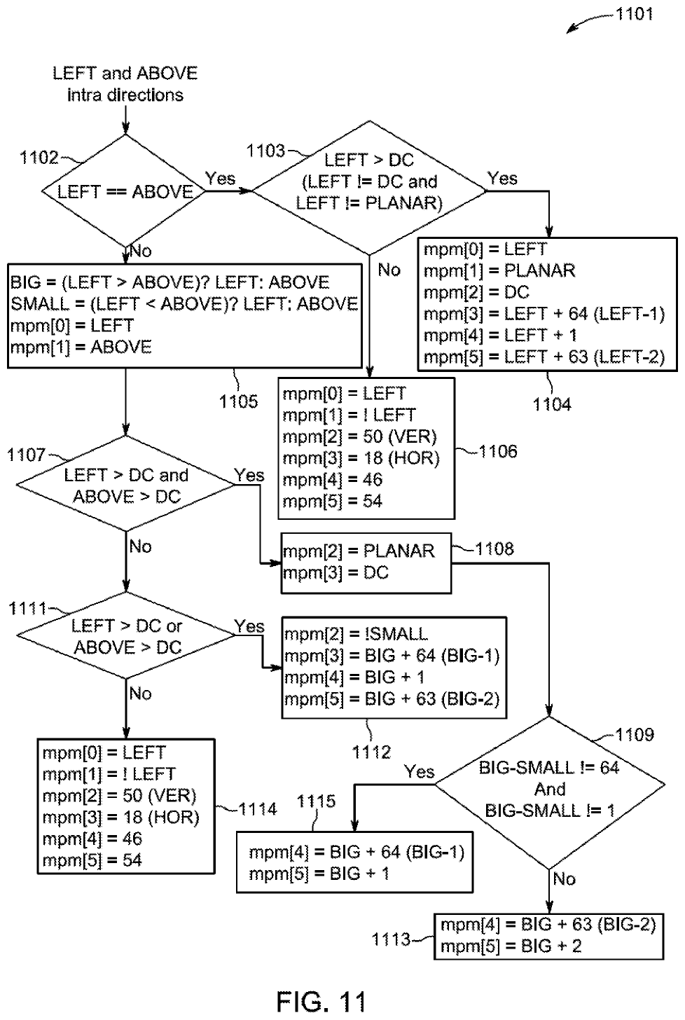

An exemplary process 1101 for deriving 6-MPM is illustrated in FIG. 11. For the non MPM coding, truncated binary coded is applied. Table 7 illustrates the process 1101 in pseudo code (shown along with the corresponding reference number in ( ) from the exemplary process 1101 of FIG. 11):

TABLE 7
Pseudo code for the proposed method

```
Determine LEFT and ABOVE intra modes
Set MPM as Default values
If (LEFT == ABOVE) (yes, 1102)
  If (LEFT > DC_idx), then set MPM as LEFT, PLANAR, DC, LEFT − 1, LEFT + 1, LEFT − 2, (1104)
  else use the default values (1106)
Else, if (LEFT > DC_idx and ABOVE > DC_idx), then set MPM as LEFT, ABOVE, PLANAR, DC, CAND −
1, CAND + 1 if LEFT and ABOVE are not circularly adjacent, (yes, 1107; 1108; yes, 1109; 1115)
else, set MPM as LEFT, ABOVE, PLANAR, DC, CAND − 2, CAND + 2, where CAND = LEFT if LEFT >
ABOVE, else CAND = ABOVE; (yes, 1107; 1108; no, 1109; 1113)
  Else if (LEFT + ABOVE > DC_idx), then (no, 1107)
  if Left is DC or PLANAR
    set MPM as ABOVE, PLANAR, DC, ABOVE − 1, ABOVE + 1, ABOVE − 2
  else
    set MPM as LEFT, PLANAR, DC, LEFT − 1, LEFT + 1, LEFT − 2
Else, use the default values (1114)
```

The two recently adopted technologies modify the MPM list. The adoption of 6-MPM increases the MPM list from 3 to 6, and MRL removes PLANAR and DC prediction modes when mrl_Idx is not zero. The integration of these two solutions is not straightforward. MRL cannot be activated with the 6-MPM extension, because one or more of the Planar and DC indexes may not be in the MPM list.

To be able to combine MRL and 6-MPM, the MPM list derivation is changed.

As shown in FIG. 10, only the intra modes of neighboring positions A and B denoted as LEFT and ABOVE are used for the generation of the MPM list.

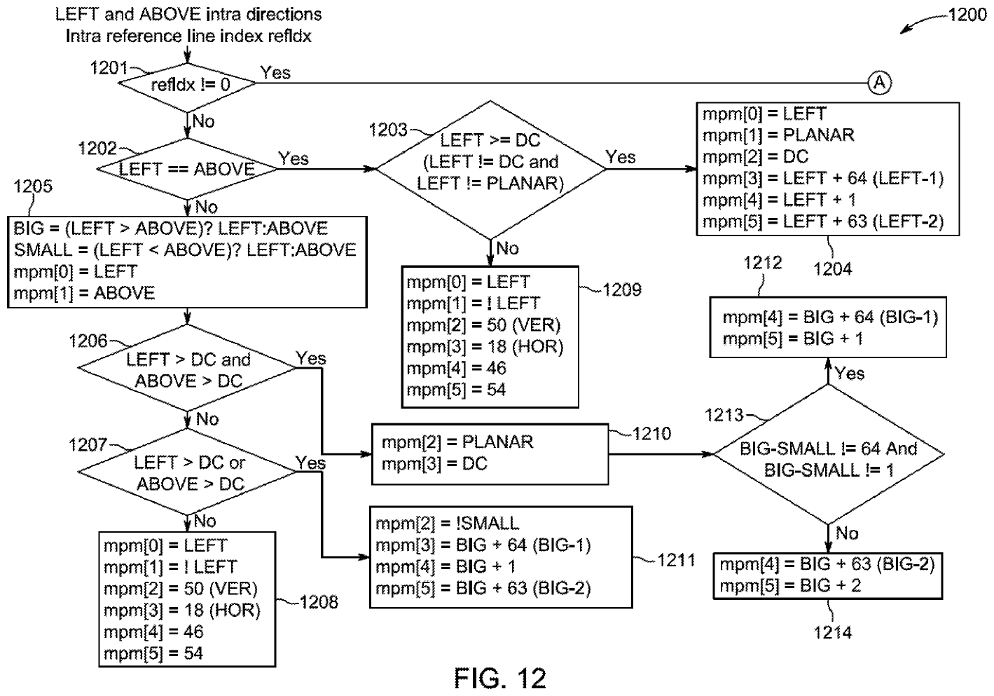

FIG. 12 illustrates an exemplary process 1200 for MPM list derivation for 6-MPM and MRL. When reference line index is greater than 0, DC and PLANAR modes are not put into the MPM list, as depicted in FIG. 12.

Accordingly, the MPM list derivation for 6-MPM and MRL can be modified as shown below (shown along with the corresponding reference number in ( ) from the exemplary process 1200 of FIG. 12):

| If ref_idx (or extendedRefLine) is 0, the 6-MPM list is constructed as above: | (no, 1201) |
|---|---|
| if LEFT and ABOVE are both DC or PLANAR | (no, 1203) |
| first mpm is set to LEFT (DC or PLANAR) | (1209) |
| second mpm is set to !LEFT (PLANAR if LEFT is DC, DC otherwise) | (1209) |
| other mpms are set to angular directions. For example, 50, 18, 54, 46 | (1209) |
| else if LEFT equals ABOVE (and thus not DC or PLANAR) | (yes, 1203) |
| first mpm is set to LEFT angular direction | (1204) |
| second mpm is set to PLANAR | (1204) |
| third mpm are set to DC | (1204) |

next mpms are set depending on LEFT. For example, LEFT + 64, LEFT + 1 and LEFT +

| | |
|---|---|
| 63 | (1204) |
| else (LEFT and ABOVE are different) | (no, 1202) |
| first mpm is set to LEFT | (1205) |
| second mpm is set to ABOVE | (1205) |
| the index of the larger MPM index is denoted as biggerIdx | |
| if both LEFT and ABOVE are not DC not PLANAR | (yes, 1206) |
| third mpm is set to PLANAR | (1210) |
| fourth mpm is set to DC | (1210) |

next mpms are set depending on mpm[biggerIdx]. For example, mpm[biggerIdx] + 64,
mpm[biggerIdx] + 1 if LEFT and ABOVE are not circularly adjacent, mpm[biggerIdx] + 63,

mpm[biggerIdx] + 2 otherwise
else (one of LEFT or ABOVE is DC or PLANAR)

third mpm is set to to !mpm[!biggerIdx] (PLANAR if mpm[!biggerIdx] is DC, DC

otherwise)

next mpms are set depending on mpm[biggerIdx]. For example, mpm[biggerIdx] + 64,

| | |
|---|---|
| mpm[biggerIdx] + 1, mpm[biggerIdx] + 3 | |
| otherwise, it needs adaptation | |
| if LEFT and ABOVE are both DC or PLANAR | (no, 1223) |

first mpms are set to angular directions as above except DC and PLANAR (50, 18, 46, 54)

(1224)

```
    fifth mpm is set to an angular direction different from mpm[0 . . . 3]. For example, 2 (1224)
    last mpm is set to an angular direction different from mpm[0 . . . 4]. For example, 66
```

| | |
|---|---|
| (1224) | |
| else if LEFT equals ABOVE | (yes, 1223) |
| first mpm is set to LEFT angular direction | (1228) |

next mpms are set depending on LEFT. For example, LEFT +/− 1, LEFT +/− 2, LEFT − 4

(1228)

as a variant, arbitrary modes not close to LEFT candidate (ex. 18 (HOR) or 50 (VER)) can

| | |
|---|---|
| be added in last MPM positions (ex. fifth MPM) to add diversity | (1229-1231) |
| else (LEFT and ABOVE are different) | |
| the smaller value between LEFT and ABOVE is denoted as SMALL | |
| the larger value between LEFT and ABOVE is denoted as BIG | |
| if SMALL is PLANAR or DC | (yes, 1218) |
| first mpm is set to BIG angular direction | (1225) |

next mpms are set depending on BIG. For example, BIG +/− 1, BIG +/− 2, BIG − 4

| | |
|---|---|
| | (1225) |
| else (LEFT and ABOVE are both angular directions) | (no, 1218) |
| first mpm is set to LEFT angular direction | (1219) |
| second mpm is set to ABOVE angular direction | (1219) |
| if LEFT and ABOVE are not circularly adjacent | (yes, 1220) |
| mpm[2] = BIG + 64 | (1226) |
| mpm[3] = BIG − 1 | (1226) |
| else (LEFT and ABOVE are circularly adjacent) | (no, 1220) |
| mpm[2] = BIG + 63 | (1221) |
| mpm[3] = BIG − 2 | (1221) |
| if LEFT and ABOVE are circularly distant of more than 2 | (yes, 1222) |
| mpm[4] = SMALL + 64 | (1227) |
| mpm[5] = SMALL + 1 | (1227) |
| else (LEFT and ABOVE are circularly adjacent (2 or less)) | (no, 1222) |
| mpm[4] = SMALL + 16 | (1232) |
| mpm[5] = SMALL + 32 | (1232) |

Note that angular indices given in the pseudo-code and figures above can be interpreted more generally:
cand+64, cand+63, cand+61, cand+1, cand+2 and cand+4, where cand is {LEFT, ABOVE, CAND} are examples of circular neighbors of candidate directions. More distant neighbors can also be chosen for diversity.
2 (top-right), 18 (HOR), 34 (DIA), 50 (VER), 66 (VDIA) are examples of arbitrary values that could be replaced by any other ones.

{SMALL+16, SMALL+32} are examples of non-neighbors. These are used as arbitrary values different than candidates already chosen (LEFT, ABOVE and neighbors).

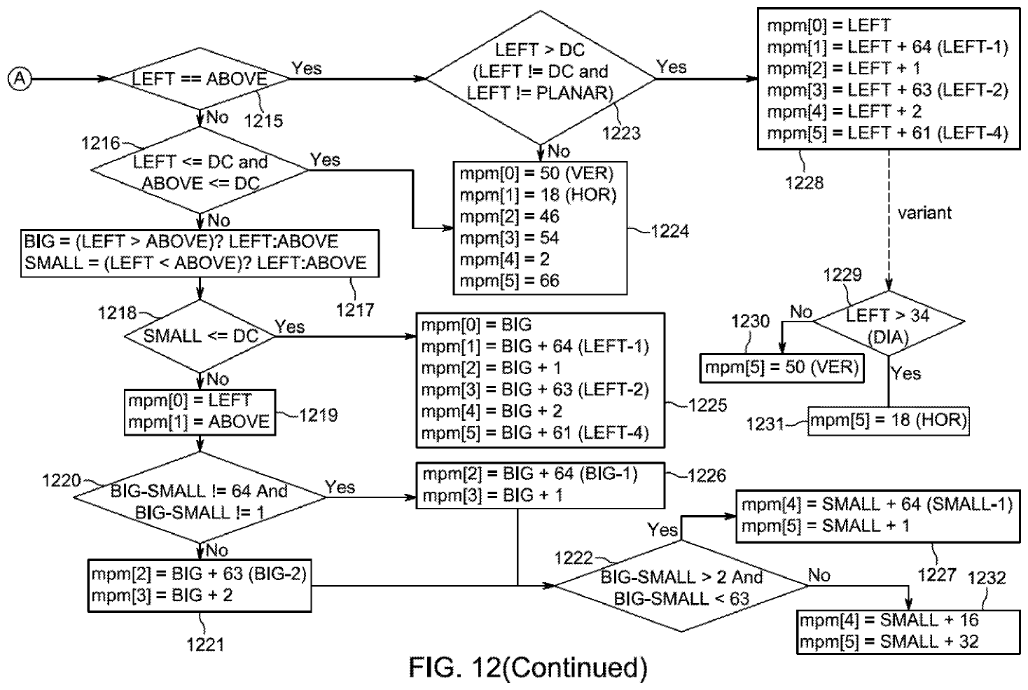

An exemplary process 1300 for how the signaling of the coding mode may be done is illustrated in FIG. 13. That is, for example, the reference line index refIdx is coded (1301), then, if the current block prediction is in the MPM list, an MPM flag is transmitted as true (1305; 1306), followed by the MPM index (1308). Otherwise, the MPM flag is transmitted as false (1307), followed by the mode index as depicted (1309-1311). If refIdx is 0, DC and PLANAR modes can be in the MPM list or in the remainder list (1311), otherwise, these modes are discarded.

Some additional embodiments are presented below. They may be used in combination with one another.

### Additional Embodiment 1—Fill ABOVE and LEFT Predictors if Default Ones are not Available

This embodiment is independent of the process presented above. It can be used without MRL, or when refIdx=0, or when 3-MPMs are used.

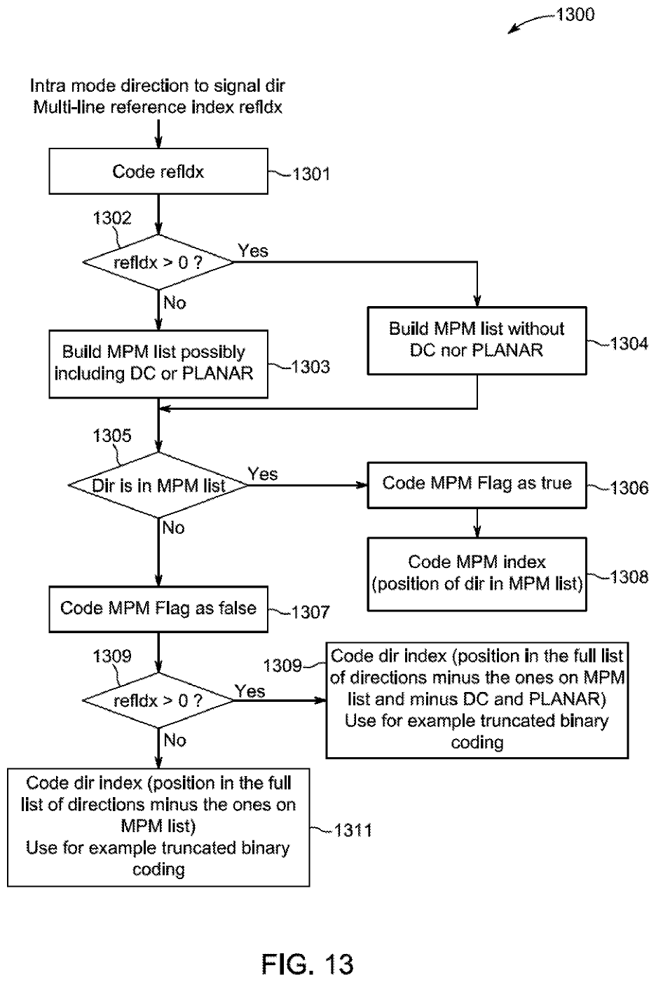

As defined above and shown in FIG. 10, only the intra modes of neighbor position A and B denoted as LEFT and ABOVE are used for MPM list generation. In case of image border, the predictor is unavailable. In addition, because of memory optimization, directions from another line of CTU are not accessible, and thus not available for prediction, as depicted in FIG. 14.

In these cases, we propose to fill the predictors with substitutes:

```
LEFT = A (default value)
ABOVE = B (default value)
if (!LEFT or !ABOVE) (one default predictor is not available)
list = {F, E, D, G, C}
listIdx = 0
while (!LEFT && listIdx < 5)
  LEFT = list [listIdx++] (set LEFT as next available predictor)
while (!ABOVE && listIdx < 5)
  ABOVE − list [listIdx++] (set ABOVE as next available predictor)
Next, build the predictor list as previously
```

### Additional Embodiment 2—Fill ABOVE and LEFT Predictors if Default Ones are DC or PLANAR when refIdx>0

This embodiment is used in combination with MRL. It can be used when 3-MPMs are used. It can be used in combination with embodiment 1.

When the reference line for intra prediction is an extended one (refIdx>0), DC and PLANAR modes are not allowed. If the default predictors are DC or PLANAR, the MPM list is constructed based on fallback modes, which is not desirable.

In these cases, we propose to fill the predictors with substitutes:

```
LEFT = A (default value)
ABOVE = B (default value)
if (LEFT <= DC or ABOVE <= DC) (one default predictor is not available, DC or PLANAR)
list = {F, E, D, G, C}
listIdx = 0
while (LEFT <= DC && listIdx < 5)
  LEFT = list [listIdx++] (set LEFT as next available predictor)
while (ABOVE <= DC && listIdx < 5)
  ABOVE = list [listIdx++] (set ABOVE as next available predictor)
Next, build the predictor list as previously
```

### Additional Embodiment 3—Use MPM List Dependent of refIdx Value; Prediction Process Depends on refIdx

This embodiment is used in combination with MRL. It is a generalization of the proposed technique. It can be used when 3-MPMs are used. It can be used in combination with embodiments 1 and 2.

In the embodiments above, the MPM list depends whether refIdx is 0 or not. Here, the chosen MPMs depend on the value of refIdx. For example:
if refIdx==0

Chosen MPMs so that the corresponding angle enables PDPC.

Choose MPMs from [PLANAR, DC, HOR, VER, DIA, VDIA, and adjacent Diagonal values {2, 2+8} {VDIA-8, VDIA}]
else if refIdx==1

Chosen MPMs different than [PLANAR, DC].

In other word, same as previously defined with refIdx !=0.
else if refIdx==2

Chosen MPMs from restricted angular modes. For example, only horizontal directional angles [2, 34(DIA)].
else if refIdx==3

Chosen MPMs from restricted angular modes, for example, only positive horizontal directional angles [2, 18(HOR)].

This can be implemented as follows:

```
LEFT = A (default value)
ABOVE = B (default value)
if (refIdx == 0)
  available modes list = [PLANAR, DC, HOR, VER, DIA, VDIA, and adjacent Diagonal values {2,
2 + 8}{VDIA-8, VDIA}]
  if LEFT not in list
    LEFT = HOR
  if ABOVE not in list
    ABOVE = VER
else if (refIdx == 1)
  available modes list = [2 . . . 66]
  if LEFT not in list
    LEFT = HOR
  if ABOVE not in list
    ABOVE = VER
else if (refIdx == 2)
  available modes list = [2 . . . 34]
  if LEFT not in list
    LEFT = HOR
  if ABOVE not in list
    ABOVE = 34 (DIA)
else if (refIdx == 3)
  available modes list = [2 . . . 18]
  if LEFT not in list
    LEFT = HOR
  if ABOVE not in list
    ABOVE = 2
```

Next, build the predictor list as previously, with modes restricted to defined list.

Here, the additional lines can have only directional modes. Since the lines farther from the target block may be less often selected than the ones nearer to the block, it may make some sense to restrict the directional modes as the refIdx increases. The restriction policy may depend on various factors and need not be arbitrary.

### Additional Embodiment 4—Modify Coding Depending on refIdx, Generalization of Embodiment 3

chose prediction dependent on refIdx

Here it is proposed to restrict MPM and available coding modes to a predefined mode list depending on the reference index. Available mode list can be chosen as the lists defined in previous embodiment

### Additional Embodiment 5—Modify Wide-Angle Intra Prediction

This embodiment is independent of previous embodiments.

We propose to disable wide angle prediction when reference index is not 0.
if refIdx>0 then do not use the remapping of angle indices for non-square blocks.

### Additional Embodiment 6—Modify Transform Coding Depending on refIdx

We propose to choose available transform coding (MTS) based on refIdx, i.e., based on which reference line is selected.

### Additional Embodiment 7—Chose Cabac Context Depending on refIdx

This embodiment is independent of any other proposed in this disclosure but can be used in combination with any other when MRL is used.

For a given PU, when it is coded with an intra mode, select CABAC context of flags and signaling element depending on the reference line index used for predicting the PU.

For example,
when coding the CBF flag (flag signaling the existence of residual coefficients, use refIdx.

Selection of the cabac context of the CBF flag:

```
if (component == Luma)
  if (refIdx == 0)
    context = 1
  else
    context = 2
else
    context = 0
```

when coding the MTS flag (flag signaling the use of a different transform than the default one), use refIdx.

When coding the MTS Flag, in addition to the quadtree depth, use refIdx:
selection of the cabac context of the MTS flag:

```
depth = min(MAX_MTS_CONTEXT_DEPTH-1, depth)
if (refIdx == 0)
  context = depth
else
  context = MAX_MTS_CONTEXT_DEPTH * refIdx + depth
```

where depth is the quadtree depth of the current TU being coded, MAX_MTS_CONTEXT_DEPTH is the maximum number of different depth values considered.
when coding the MTS index (index signaling which transform to use when MTS flag is true), use refIdx.

When coding the MTS index, use refIdx:

selection of the CABAC context of the MTS index: the MTS flag is coded using a 2-bit code word. each bit being coded with a separate context context0 for the first bit and context1 for the second bit.

```
if (refIdx == 0)
  context0 = 0
  context1 = 1
else
  context0 = 2
  context1 = 3
```

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

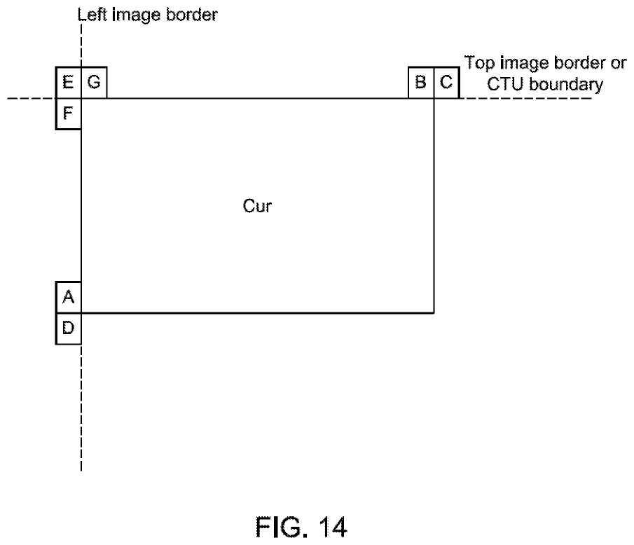

The aspects described and contemplated in this application can be implemented in many different forms. FIGS. 15, 16 and 17 below provide some embodiments, but other embodiments are contemplated and the discussion of FIGS. 15, 16 and 17 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

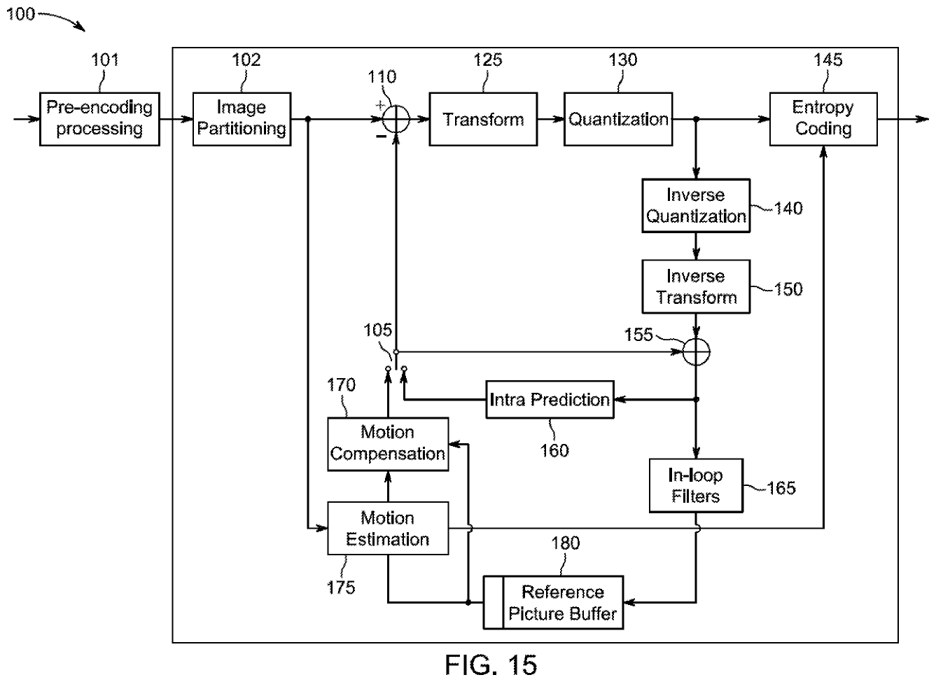

Various methods and other aspects described in this application can be used to modify modules, for example, the intra prediction, entropy coding, and/or decoding modules (160, 360, 145, 330), of a video encoder 100 and decoder 200 as shown in FIG. 15 and FIG. 16. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

According to an embodiment, a method for video encoding is provided, comprising: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; and encoding the current block based on the respective number of candidate modes for each of the multiple reference lines.

According to another embodiment, a method for video decoding is provided, comprising: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; and decoding the current block based on the respective number of candidate modes for each of the multiple reference lines.

According to another embodiment, an apparatus for video encoding is provided, comprising: means for obtaining multiple reference lines for intra prediction of a current block, wherein the multiple reference lines include at least one reference line that is immediately adjacent to the current block and at least one reference line that is not immediately adjacent to the current block; means for obtaining respectively a number of intra prediction candidate modes for each of the multiple reference lines; and means for encoding the current block based on the respective number of candidate modes for each of the multiple reference lines.

According to another embodiment, an apparatus for video decoding is provided, comprising: means for obtaining multiple reference lines for intra prediction of a current block, wherein the multiple reference lines include at least one reference line that is immediately adjacent to the current block and at least one reference line that is not immediately adjacent to the current block; means for obtaining respectively a number of intra prediction candidate modes for each of the multiple reference lines; and means for decoding the current block based on the respective number of candidate modes for each of the multiple reference lines.

According to another embodiment, an apparatus for video encoding is presented, comprising one or more processors, wherein said one or more processors are configured to: obtain multiple reference lines for intra prediction of a current block, wherein the multiple reference lines include at least one reference line that is immediately adjacent to the current block and at least one reference line that is not immediately adjacent to the current block; obtain respectively a number of intra prediction candidate modes for each of the multiple reference lines; and encode the current block based on the respective number of candidate modes for each of the multiple reference lines.

According to another embodiment, an apparatus for video decoding is presented, comprising one or more processors, wherein said one or more processors are configured to: obtain multiple reference lines for intra prediction of a current block, wherein the multiple reference lines include at least one reference line that is immediately adjacent to the current block and at least one reference line that is not immediately adjacent to the current block; obtain respectively a number of intra prediction candidate modes for each of the multiple reference lines; and encode the current block based on the respective number of candidate modes for each of the multiple reference lines.

According to another embodiment, a bitsteam is formed by performing: obtaining multiple reference lines for intra prediction of a current block, wherein the multiple reference lines include at least one reference line that is immediately adjacent to the current block and at least one reference line that is not immediately adjacent to the current block; obtaining respectively a number of intra prediction candidate modes for each of the multiple reference lines; encoding the current block based on the respective number of candidate modes for each of the multiple reference lines; and forming the bitstream comprising the encoded current block.

According to another embodiment, a same number is used for the respective number of candidate modes for each of the multiple reference lines.

According to another embodiment, the candidate modes are most probable modes (MPMs).

According to another embodiment, the respective number of candidate modes for each of the multiple reference lines is 3 or 6.

According to another embodiment, the candidate modes for a reference line that is not immediately adjacent to the current block exclude one or more of DC and planar modes.

According to another embodiment, the candidate modes for a reference line are based on one or more intra prediction modes for a left neighboring block and an above neighboring block.

According to another embodiment, if the left neighboring block or the above neighboring block is not available, the intra prediction mode for the left neighboring block or the above neighboring block is predicted by an intra prediction mode of another neighboring block.

According to another embodiment, the candidate modes are provided in a list of candidate modes.

According to another embodiment, the candidate modes depend on a distance between a corresponding reference line and the current block.

According to another embodiment, selection of the candidate modes becomes more restrictive as the distance becomes larger.

According to another embodiment, wide-angle intra prediction is disabled when the respective reference line is not immediately adjacent to the current block.

According to another embodiment, a set of transforms available for multiple transform selection depends on which reference line is used for the intra prediction.

According to another embodiment, context for context adaptive binary arithmetic coding of syntax elements related to coding of the candidate modes depends on which reference line is used for the intra prediction.

FIG. 15 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 16 illustrates a block diagram of a video decoder 200. In the decoder 200, a bitstream is decoded by the decoder elements as described below. Video decoder 200 generally performs a decoding pass reciprocal to the encoding pass as described in FIG. 15. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

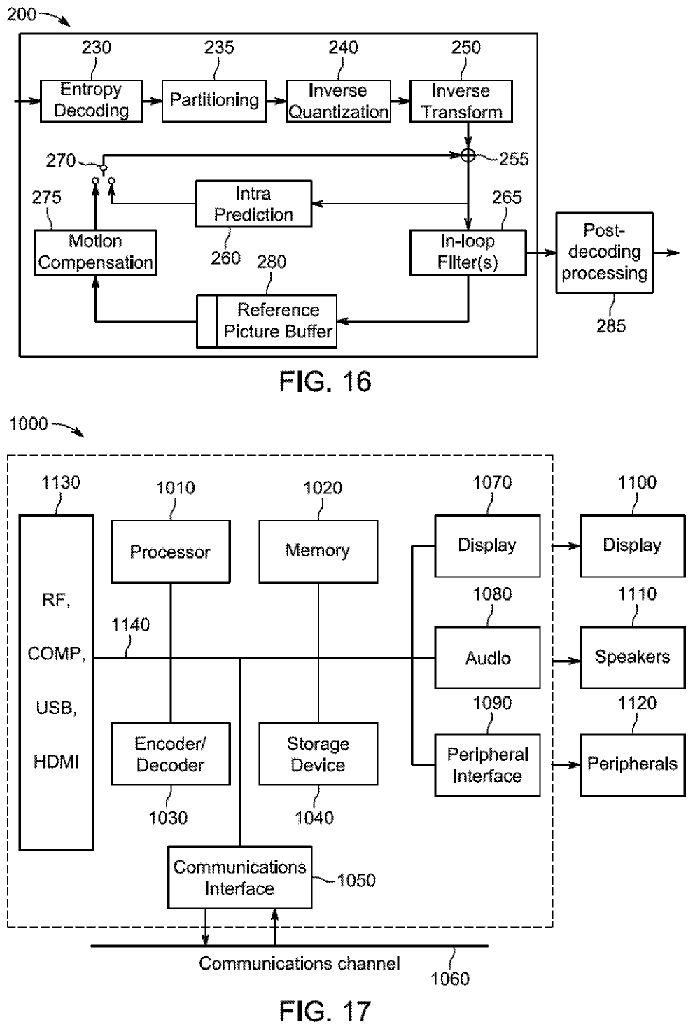

FIG. 17 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 10, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other devices. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of intra modes, or reference lines for intra prediction. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method for video encoding or decoding, comprising:
obtaining multiple reference lines for intra prediction of a current block, wherein the multiple reference lines include at least one reference line that is immediately adjacent to the current block and at least one reference line that is not immediately adjacent to the current block;
obtaining respectively a number of intra prediction candidate modes for each of the multiple reference lines, wherein the candidate modes depend on a distance between a corresponding reference line and the current block; and
encoding or decoding the current block based on the respective number of candidate modes for each of the multiple reference lines.

2-7. (canceled)

8. The method of claim 1, wherein the candidate modes for a reference line that is not immediately adjacent to the current block exclude one or more of DC and planar modes.

9. The method of claim 1, wherein the candidate modes for a reference line are based on one or more intra prediction modes for a left neighboring block and an above neighboring block.

10. The method of claim 9, wherein if the left neighboring block or the above neighboring block is not available, the intra prediction mode for the left neighboring block or the above neighboring block is predicted by an intra prediction mode of another neighboring block.

11-12. (canceled)

13. The method of claim 1, wherein selection of the candidate modes becomes more restrictive as the distance becomes larger.

14. The method of claim 1, wherein wide-angle intra prediction is disabled when the respective reference line is not immediately adjacent to the current block.

15. The method of claim 1, wherein a set of transforms available for multiple transform selection depends on which reference line is used for the intra prediction.

16. The method of claim 1, wherein context for context adaptive binary arithmetic coding of syntax elements related to coding of the candidate modes depends on which reference line is used for the intra prediction.

17-19. (canceled)

20. An apparatus for video encoding or decoding, comprising one or more processors, wherein the one or more processors are configured to:
obtain multiple reference lines for intra prediction of a current block, wherein the multiple reference lines include at least one reference line that is immediately adjacent to the current block and at least one reference line that is not immediately adjacent to the current block;
obtain respectively a number of intra prediction candidate modes for each of the multiple reference lines, wherein the candidate modes depend on a distance between a corresponding reference line and the current block; and
encode or decode the current block based on the respective number of candidate modes for each of the multiple reference lines.

21. The apparatus of claim 20, wherein the candidate modes for a reference line that is not immediately adjacent to the current block exclude one or more of DC and planar modes.

22. The apparatus of claim 20, wherein the candidate modes for a reference line are based on one or more intra prediction modes for a left neighboring block and an above neighboring block.

23. The apparatus of claim 22, wherein if the left neighboring block or the above neighboring block is not available, the intra prediction mode for the left neighboring block or the above neighboring block is predicted by an intra prediction mode of another neighboring block.

24. The apparatus of claim 20, wherein selection of the candidate modes becomes more restrictive as the distance becomes larger.

25. The apparatus of claim 20, wherein wide-angle intra prediction is disabled when the respective reference line is not immediately adjacent to the current block.

26. The apparatus of claim 20, wherein a set of transforms available for multiple transform selection depends on which reference line is used for the intra prediction.

27. The apparatus of claim 20, wherein context for context adaptive binary arithmetic coding of syntax elements related to coding of the candidate modes depends on which reference line is used for the intra prediction.
